(19) United States
(12) Patent Application Publication
(10) Pub. No.: US 2019/0294174 A1
(43) Pub. Date: Sep. 26, 2019

(54) VEHICLE CONTROL SYSTEM, VEHICLE CONTROL METHOD, AND STORAGE MEDIUM

(71) Applicant: HONDA MOTOR CO., LTD., Tokyo (JP)

(72) Inventor: Susumu Iwamoto, Tokyo (JP)

(21) Appl. No.: 16/351,549

(22) Filed: Mar. 13, 2019

(30) Foreign Application Priority Data
Mar. 20, 2018 (JP) 2018-053422

(51) Int. Cl. G05D 1/02; G05D 1/00; B60W 30/09; B60W 30/095; G06K 9/00

(52) U.S. Cl. CPC G05D 1/0221; G05D 1/0088; B60W 30/09; G05D 2201/0213; B60W 30/0956; G06K 9/00791; B60W 30/0953

(57) ABSTRACT

A vehicle control system includes a determination result generation unit that generates a first determination result made by an occupant or a device mounted on a subject vehicle in relation to a first matter that is related to traveling of the subject vehicle and generates a second determination result by performing determination based on learning data in relation to a second matter that is related to the first determination result, and a determination decision unit that decides a determination related to the first matter and the second matter based on the first determination result, the second determination result, and external information, in a case where the first determination result and the second determination result are different from each other.

### CROSS-REFERENCE TO RELATED APPLICATION

Priority is claimed on Japanese Patent Application No. 2018-053422, filed Mar. 20, 2018, the content of which is incorporated herein by reference.

### BACKGROUND OF THE INVENTION

### Field of the Invention

The present invention relates to a vehicle control system, a vehicle control method, and a storage medium.

### Description of Related Art

In the related art, in various devices for controlling traveling of a vehicle, a structure for controlling a driving operation of a driver by a function of machine learning, artificial intelligence (AI), or the like is known. In relation to this, a technique for limiting gear change to a gear change stage at which a limit has been imposed by AI control, in a case where control of gear change of a vehicle by an AI and control of gear change of the vehicle by manual of an the occupant are performed at the same time is known (for example, Japanese Unexamined Patent Application, First Publication No.

2011-179590).

### SUMMARY OF THE INVENTION

However, in a case where a plurality of AI functions are mounted on a vehicle, contradiction occurs in a determination result by each of the AI functions, final determination is not able to be made, or determination is delayed in some cases. In learning various situations such that contradiction is not caused in the determination result, there are concerns that it is necessary to combine a large number of traveling situations, it takes time to generate learning data, and a process load on a system is increased.

An aspect of the present invention has been made in consideration of such a circumstance, and an object of the aspect of the present invention is to provide a vehicle control system, a vehicle control method, and a storage medium capable of performing more suitable control determination with respect to a vehicle.

A vehicle control system, a vehicle control method, and a storage medium according to the present invention adopt the following constitutions.

(1): A vehicle control system according to an aspect of the present invention includes a determination result generation unit that generates a first determination result made by an occupant or a device mounted on a subject vehicle in relation to a first matter that is related to traveling of the subject vehicle and generates a second determination result by performing determination based on learning data in relation to a second matter that is related to the first determination result, and a determination decision unit that decides a determination related to the first matter and the second matter based on the first determination result, the second determination result, and external information, in a case where the first determination result and the second determination result are different from each other.

(2): In the aspect of (1) described above, the determination decision unit decides the determination related to the first matter and the second matter with reference to a table capable of acquiring determination decision rule data for deciding the determination related to the first matter and the second matter, based on a combination of a determination pattern of the first determination result and the second determination result and the external information.

(3): In the aspect of (1) described above, the determination decision unit feeds back the determination result decided based on the first determination result, the second determination result, and the external information to the learning data.

(4): In the aspect of (1) described above, the determination result generation unit sets a determination result related to a control amount of first traveling control of the subject vehicle as the first determination result and sets a determination result related to a control amount of second traveling control of the subject vehicle as the second determination result, the external information includes a traveling state or a surrounding situation of the subject vehicle, and the determination decision unit adjusts one or both of the control amount of the first traveling control and the control amount of the second traveling control based on the external information in a case where contradiction occurs in vehicle control by reflecting the control amount of the first traveling control and the control amount of the second traveling control on the subject vehicle.

(5): In the aspect of (1) described above, the determination result generation unit sets a determination result related to traveling control of automated driving control of a first vehicle as the first determination result and sets a determination result related to traveling control of automated driving control of a second vehicle as the second determination result, the external information includes traveling states or surrounding situations of the first vehicle and the second vehicle, and in a case where there is a possibility that the first vehicle and the second vehicle come in contact with each other, the determination decision unit decelerates or stops one or both of the first vehicle or the second vehicle based on the first determination result, the second determination result, and the external information.

(6): In the aspect of (5) described above, the determination decision unit decides a vehicle in which deceleration is to be stopped or which is to be preferentially started after decelerating or stopping the first vehicle and the second vehicle.

(7): In the aspect of (5) described above, the determination decision unit decelerates or stops one or both of the first vehicle or the second vehicle based on a first determination result based on a determination result of an obstacle based on the traveling state or the surrounding situation of the first vehicle and a determination result of a possibility of contact with the obstacle, a second determination result based on a determination result of an obstacle based on the traveling state or a surrounding situation of the second vehicle and a determination result of a possibility of contact with the obstacle, and the external information.

(8): In the aspect of (5) described above, the determination decision unit is provided in an external device capable of communicating with the first vehicle and the second vehicle.

(9): A vehicle control system according to an aspect of the present invention includes an operation receiving unit that receives an operation of a user, a determination result generation unit that generates a determination result based on learning data in relation to a first matter, and a determination decision unit that decides a determination related to the first matter based on the determination result of the determination result generation unit, the operation received by the operation receiving unit, and external information, in a case where an operation different from the determination result determined by the determination result generation unit is performed based on the operation received by the operation receiving unit.

(10): A vehicle control method according to an aspect of the present invention is a vehicle control method that causes a vehicle control system to generate a first determination result made by an occupant or a device in relation to a first matter that is related to traveling of a subject vehicle, generate a second determination result by performing determination based on learning data in relation to a second matter that is related to the first determination result, and decide determination related to the first matter and the second matter based on the first determination result, the second determination result, and external information, in a case where the first determination result and the second determination result are different from each other.

(11): A storage medium according to an aspect of the present invention is a computer-readable non-transitory storage medium storing a program that causes a vehicle control system to generate a first determination result made by an occupant or a device in relation to a first matter that is related to traveling of a subject vehicle, generate a second determination result by performing determination based on learning data in relation to a second matter that is related to the first determination result, and decide determination related to the first matter and the second matter based on the first determination result, the second determination result, and external information, in a case where the first determination result and the second determination result are different from each other.

According to the aspects of (1) to (11) described above, it is possible to perform more suitable control determination with respect to a vehicle.

### BRIEF DESCRIPTION OF THE DRAWINGS

FIG. 1 is a constitution diagram of a vehicle system using a vehicle control system according to a first embodiment.

FIG. 2 is a functional constitution diagram of a first control unit, a second control unit, a third control unit, and a storage unit according to the first embodiment.

FIG. 3 is a diagram for explaining a process of a determination result generation unit.

FIG. 4 is a diagram for explaining a process of the determination result generation unit in a situation in which a subject vehicle travels at an intersection.

FIG. 5 is a diagram showing an example of a content of a determination decision rule table.

FIG. 6 is a flowchart showing a flow of a process executed by a driving support control device of the first embodiment.

FIG. 7 is a constitution diagram of a vehicle system of a second embodiment.

FIG. 8 is a functional constitution diagram of a first control unit, a second control unit, a third control unit, and a storage unit according to the second embodiment.

FIG. 9 is a diagram for explaining a process of a driving support control device at an intersection.

FIG. 10 is a sequence diagram showing a flow of a process executed by the driving support control device of the second embodiment.

FIG. 11 is a diagram showing an example of a hardware constitution of the driving support control device according to an embodiment.

### DETAILED DESCRIPTION OF THE INVENTION

Hereinafter, embodiments of a vehicle control system, a vehicle control method, and a storage medium of the present invention will be described with reference to the drawings. A vehicle control device of the embodiment is applied to an automated driving vehicle. For example, automated driving is executing driving control by controlling one or both of steering or acceleration and deceleration of a vehicle. For example, the automated driving may include driving control by a driving support device such as adaptive cruise control (ACC), lane keeping assist (LKAS), auto lane changing (ALC), or the like. For example, the driving support device includes a steering control device that mainly controls steering of a vehicle and a distribution control device that mainly controls distribution of left and right braking and driving force of the vehicle. In the following, a case where a law on a left side is applied to the present invention will be described, but in a case where a law on a right side is applied to the present invention, it is only necessary to reverse a left and a right.

### First Embodiment

In a first embodiment, a case where a vehicle has a function of deciding one determination result on the basis of a plurality of determination results related to traveling control will be described.

[Overall Constitution]

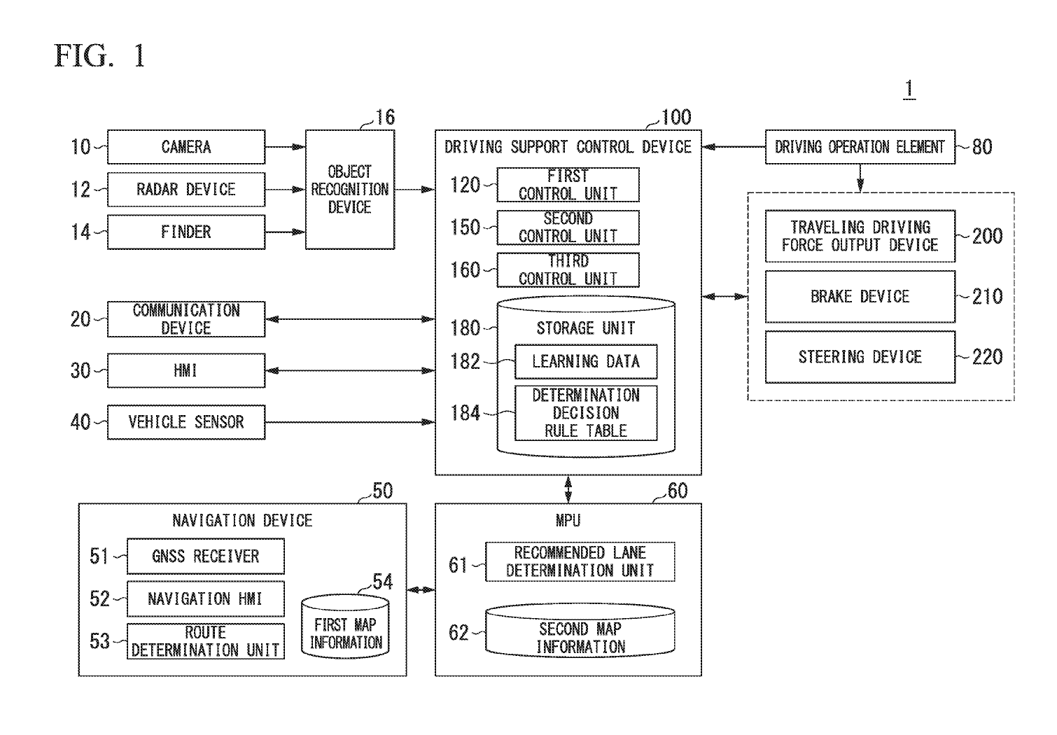

FIG. 1 is a constitution diagram of a vehicle system 1 using a vehicle control system according to the first embodiment. A vehicle in which the vehicle system 1 is mounted is, for example, a vehicle such as a two-wheeled vehicle, a three-wheeled vehicle, or a four-wheeled vehicle, and a driving source of the vehicle is an internal combustion engine such as a diesel engine or a gasoline engine, an electric motor, or a combination thereof. The electric motor operates using electric power generated by a generator connected to the internal combustion engine or electric power discharged by a secondary battery or a fuel cell.

For example, the vehicle system 1 includes a camera 10, a radar device 12, a finder 14, an object recognition device 16, a communication device 20, a human machine interface (HMI) 30, a vehicle sensor 40, a navigation device 50, a map positioning unit (MPU) 60, a driving operation element 80, a driving support control device 100, a traveling driving force output device 200, a brake device 210, and a steering device 220. Such devices and instruments are connected to each other by a multiple communication line such as a controller area network (CAN) communication line, a serial communication line, a wireless communication network, or the like. The constitution shown in FIG. 1 is merely an example, and a part of the constitution may be omitted or another constitution may be further added. The driving support control device 100 is an example of the “vehicle control system”. A combination of the HMI 30 and the driving operation element 80 is an example of an “operation receiving unit”.

For example, the camera 10 is a digital camera using a solid imaging element such as a charge coupled device (CCD) or a complementary metal oxide semiconductor (CMOS). The camera 10 is attached to an arbitrary place on the vehicle (hereinafter, a subject vehicle M) in which the vehicle system 1 is mounted. In a case of forward imaging, the camera 10 is attached to an upper portion of a front windshield, a rear surface of a rearview mirror, or the like. For example, the camera 10 periodically repeats imaging of the surroundings of the subject vehicle M. The camera 10 may be a stereo camera.

The radar device 12 radiates radio waves such as millimeter waves or the like to the surroundings of the subject vehicle M and detects at least the position (distance and direction) of an object by detecting radio waves (reflected waves) reflected by the object. The radar device 12 is attached to an arbitrary place on the subject vehicle M. The radar device 12 may detect the position and the speed of the object by a frequency modulated continuous wave (FM-CW) method.

The finder 14 is a light detection and ranging (LIDAR). The finder 14 irradiates light around the subject vehicle M and measures scattered light. The finder 14 detects the distance to the object on the basis of a time from light emission to light reception. For example, the irradiated light is laser light of a pulse shape. The finder 14 is attached to an arbitrary place on the subject vehicle M.

The object recognition device 16 performs a sensor fusion process on a detection result by a part or all of the camera 10, the radar device 12, and the finder 14 to recognize a position, a type, a speed, and the like of the object. The object recognition device 16 outputs a recognition result to the driving support control device 100. The object recognition device 16 may output the detection result of the camera 10, the radar device 12, and the finder 14 as they are to the driving support control device 100. The object recognition device 16 may be omitted from the vehicle system 1. The camera 10 includes an infrared camera that captures an image of a change of a surface temperature of an object, in addition to capturing of a normal image. Between normal imaging and infrared imaging may be switched by a function of the camera 10.

For example, the communication device 20 communicates with another vehicle that is present around the subject vehicle M using a cellular network, a Wi-Fi network, Bluetooth (registered trademark), dedicated short range communication (DSRC), or the like, or communicates with various server devices through a wireless base station.

The HMI 30 presents various types of information to an occupant of the subject vehicle M and receives an input operation by the occupant. The HMI 30 includes various display devices, speakers, buzzers, touch panels, switches, keys, light emitting devices provided in a vehicle interior, and the like.

The vehicle sensor 40 includes a vehicle speed sensor that detects a speed of the subject vehicle M, an acceleration sensor that detects acceleration, a yaw rate sensor that detects an angular velocity around a vertical axis, a direction sensor that detects a direction of the subject vehicle M, and the like. For example, the acceleration sensor may include a sensor that detects longitudinal acceleration or lateral acceleration. For example, the longitudinal acceleration is acceleration with respect to a progress direction of the subject vehicle M. For example, the lateral acceleration is acceleration received in a vehicle width direction of the subject vehicle M with respect to the progress direction of the subject vehicle M.

The vehicle sensor 40 may include a contact detection sensor that detects the presence or absence of contact from the outside and the strength of the contact at an arbitrary position of a body portion of the subject vehicle M. The vehicle sensor 40 may include a vibration sensor that detects a vibration of the subject vehicle M and a sound detection sensor that detects a sound generated from the subject vehicle M or in the vicinity of the subject vehicle M.

For example, the navigation device 50 includes a global navigation satellite system (GNSS) receiver 51, a navigation HMI 52, and a route determination unit 53. The navigation device 50 holds first map information 54 in a storage device such as a hard disk drive (HDD) or a flash memory. The GNSS receiver 51 specifies the position of the subject vehicle M on the basis of a signal received from a GNSS satellite. The position of the subject vehicle M may be specified or supplemented by an inertial navigation system (INS) using an output of the vehicle sensor 40. The navigation HMI 52 includes a display device, a speaker, a touch panel, a key, and the like. A part or all of the navigation HMI 52 may be shared with the HMI 30 described above. For example, the route determination unit 53 determines a route (hereinafter referred to as a route on a map) from the position of the subject vehicle M specified by the GNSS receiver 51 (or an input arbitrary position) to a destination input by the occupant using the navigation HMI 52 in a manned state or a destination transmitted from an external communication terminal and received by the communication device 20 in an unmanned state, by referring to the first map information 54. For example, the first map information 54 is information in which a road shape is expressed by a link indicating a road and nodes connected by the link. The first map information 54 may include information related to a road sign for the link. The first map information 54 may include a curvature of the road, point of interest (POI) information, or the like. The route on the map is output to the MPU 60. The navigation device 50 may perform route guidance using the navigation HMI 52 on the basis of the route on the map. For example, the navigation device 50 may be realized by a function of a terminal device such as a smartphone or a tablet terminal possessed by the occupant. The navigation device 50 may transmit a current position and a destination to a navigation server through the communication device 20 and acquire the same route as the route on the map from the navigation server.

For example, the MPU 60 includes a recommended lane determination unit 61 and holds second map information 62 in the storage device such as an HDD or a flash memory. The recommended lane determination unit 61 divides the route on the map provided from the navigation device 50 into a plurality of blocks (for example, divides the route into intervals of 100 [m] in a vehicle progress direction), and determines a recommended lane for each block by referring to the second map information 62. The recommended lane determination unit 61 determines the number of a lane from the left that the vehicle travels in. In a case where a branching position is present in the route on the map, the recommended lane determination unit 61 determines the recommended lane so that the subject vehicle M is able to travel on a reasonable travel route for progressing to a branch destination.

The second map information 62 is map information with accuracy higher than that of the first map information 54. For example, the second map information 62 may include information on the center of a lane, information on a boundary of a lane, or the like. The second map information 62 may include road information, traffic regulation information, address information (an address and a postal code), facility information, telephone number information, and the like. The second map information 62 may be updated at any time by the communication device 20 communicating with another device.

The driving operation element 80 includes, for example, an acceleration pedal, a brake pedal, a shift lever, a steering wheel, a modified steering wheel, a joystick, and other operation elements. A sensor that detects an operation amount or presence or absence of an operation is attached to the driving operation element 80, and a detection result of the sensor is output to a part or all of the driving support control device 100, or the traveling driving force output device 200, the brake device 210, and the steering device 220. A grip sensor that detects whether or not the occupant grips the steering wheel may be attached to the steering wheel.

For example, the driving support control device 100 includes a first control unit 120, a second control unit 150, a third control unit 160, and a storage unit 180. For example, each of such constitution elements except for the storage unit 180 is realized by a hardware processor such as a central processing unit (CPU) executing a program (software). Some or all of such constitution elements may be realized by hardware (a circuit unit including a circuitry) such as a large scale integration (LSI), an application specific integrated circuit (ASIC), a field-programmable gate array (FPGA), or a graphics processing unit (GPU), or may be realized by software and hardware in cooperation. The program may be stored in a storage device such as an HDD or a flash memory of the driving support control device 100 in advance. Alternatively, the program may be stored in a detachable storage medium such as a DVD or a CD-ROM and may be installed in the HDD or the flash memory of the driving support control device 100 by the storage medium attached to a drive device.

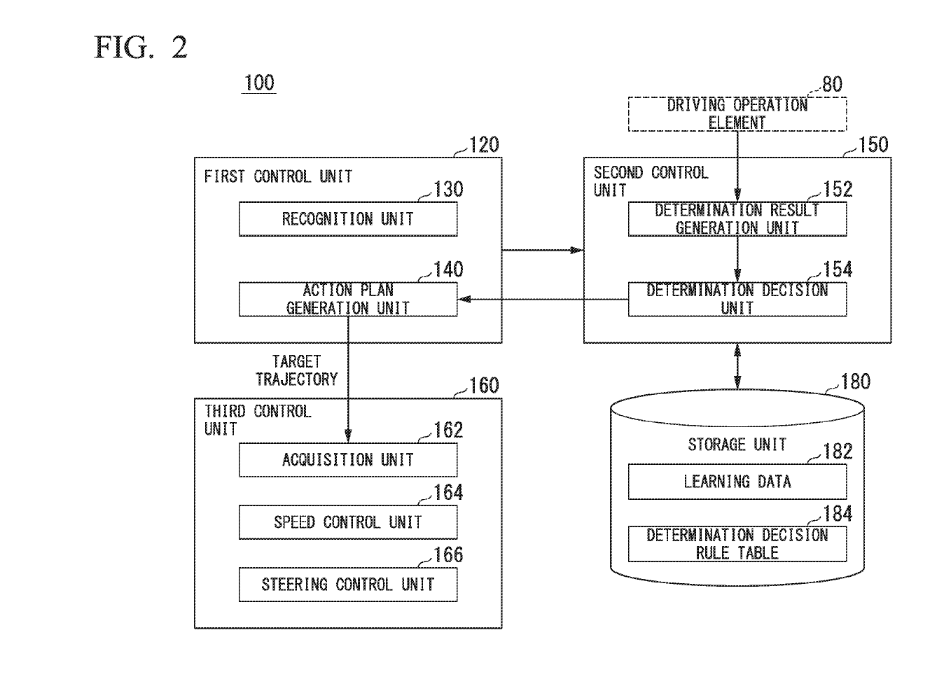

FIG. 2 is a functional constitution diagram of the first control unit 120, the second control unit 150, the third control unit 160, and the storage unit 180 according to the first embodiment. For example, the first control unit 120 includes a recognition unit 130 and an action plan generation unit 140.

For example, the first control unit 120 realizes a function of artificial intelligence (AI) and a function of a previously given model in parallel. For example, a function of “recognizing an intersection” may be executed in parallel with recognition of an intersection by deep learning or the like and recognition based on a previously given condition (there is a pattern matching signal, a road sign, or the like) and may be realized by giving scores to both sides and comprehensively evaluating the scores. Therefore, reliability of automated driving is guaranteed.

The recognition unit 130 recognizes states such as the position, the orientation, the speed and the acceleration of the object around the subject vehicle M, on the basis of information input from the camera 10, the radar device 12, and the finder 14 through the object recognition device 16. The object includes, for example, a person such as a pedestrian, a moving object such as another vehicle, an obstacle on the road such as a construction site, a package dropped from a loaded vehicle, and the like. The object may include a curbstone, a median strip, a side groove, a guardrail, a wall, and the like. The position of the object is recognized as a position in absolute coordinates using a representative point (a center of gravity, a drive shaft center, or the like) of the subject vehicle M as an origin and is used in control. The position of the object may be represented by the representative point such as the center of gravity or a corner of the object, or may be represented by an expressed region. For example, in a case where the object is another vehicle, a “state” of the object may include an acceleration, a jerk, or an “action state” (for example, whether or not the object is changing a lane or trying to change a lane).

For example, the recognition unit 130 recognizes a lane (traveling lane) on which the subject vehicle M is traveling. For example, the recognition unit 130 recognizes the traveling lane by comparing a pattern of a road lane marking (for example, an arrangement of a solid line and a broken line) obtained from the second map information 62 with a pattern of a road lane marking around the subject vehicle M recognized from the image captured by the camera 10. The recognition unit 130 may recognize the traveling lane by recognizing a traveling road boundary (a road boundary) including a road lane marking, a road shoulder, a road side band, a curb stone, a median strip, a guard rail, and the like, without limiting to recognizing a road lane marking. In this recognition, the position of the subject vehicle M acquired from the navigation device 50 or a process result by an INS may be added. The recognition unit 130 may recognize a width, a height, and a shape of the object, a type (for example, a vehicle type of the other vehicle), or the like on the basis of the image captured by the camera 10. The recognition unit 130 recognizes a road sign, a red light, a toll gate, a road structure, and other road events.

When recognizing the traveling lane, the recognition unit 130 recognizes the position and a posture of the subject vehicle M with respect to the traveling lane. For example, the recognition unit 130 may recognize a deviation of a reference point (for example, a center of gravity) of the subject vehicle M from a center of the lane and an angle formed by a line connecting the center of the lane of a progress direction of the subject vehicle M as a relative position and the posture of the subject vehicle M with respect to the traveling lane. Instead of this, the recognition unit 130 may recognize a position of the reference point of the subject vehicle M with respect to one of side end portions (the road lane marking or the road boundary) of the traveling lane, or the like as the relative position of the subject vehicle M with respect to the traveling lane. The recognition unit 130 may recognize a structure (for example, a utility pole, a median strip, and the like) on the road on the basis of the first map information 54 or the second map information 62.

In principle, the action plan generation unit 140 generates a target trajectory along which the subject vehicle M automatically travels in the future so that the subject vehicle M travels on the recommended lane determined by the recommended lane determination unit 61 and furthermore the subject vehicle M is able to cope with the surrounding situation of the subject vehicle M. The target trajectory includes, for example, a speed element. For example, the target trajectory is expressed as a sequence of points (trajectory points) where the reference point (for example, the center of gravity G) of the subject vehicle M reaches. The trajectory point is a point where the subject vehicle M reaches for each predetermined traveling distance (for example, about several [m]) at a road distance, and separately from that, a target speed and a target acceleration for each predetermined sampling time (for example, about 0 comma several [sec]) are generated as part of the target trajectory. For example, the target speed for each sampling time is determined on the basis of a high rank target speed determined for each passing road. For example, the high rank target speed may be determined on the basis of a limit speed or a legal speed, or may be arbitrarily set by the occupant or within a predetermined range from the limit speed or the legal speed. For example, the target speed in the claims corresponds to the high rank target speed. The trajectory point may be a position where the subject vehicle M reaches at a sampling time for each predetermined sampling time. In this case, information on the target speed and the target acceleration is expressed by an interval between the trajectory points.

In generating the target trajectory, the action plan generation unit 140 may set an event of the automated driving. The event of the automated driving includes a constant speed traveling event, a low speed following traveling event, a lane change event, a lane keeping traveling event, a branch event, a merge event, a takeover event, an avoidance event, and the like. Such events also include an event that supports a part of the driving operation by the driver.

For example, the action plan generation unit 140 generates a target trajectory on the basis of the determination decision rule data of the traveling control of the subject vehicle M from the second control unit 150.

The second control unit 150 includes, for example, a determination result generation unit 152 and a determination decision unit 154. The determination result generation unit 152 generates a determination result made by the operation of the occupant or the device in relation to a matter that is related to the traveling of the subject vehicle M or a determination result derived by an AI function based on the learning data stored by the storage unit 180. For example, the matter is information related to a behavior of the subject vehicle M, and includes a progress direction of the subject vehicle M, a phenomenon occurring in the subject vehicle M, a phenomenon expected to occur in the future, or the like. For example, the phenomenon includes a slip of the subject vehicle M, or a contact avoidance traveling against an approach of an object such as the other vehicle M. For example, the determination result is a determination result for future traveling control of the subject vehicle M. For example, the AI function includes a method of finding regularity or relevance from a plurality of pieces of data and determining things using machine learning that performs determination or prediction, and a method of determining things using deep learning for learning setting of a feature amount, combination contents, and the like, by using a multilayered structure algorithm (for example, a neural network). Details of a function of the determination result generation unit 152 will be described later.

The determination decision unit 154 acquires determination decision rule data related to the future traveling control of the subject vehicle M on the basis of a plurality of determination results generated by the determination result generation unit 152, and outputs the acquired determination decision rule data to the action plan generation unit 140. Details of a function of the determination decision unit 154 will be described later.

The third control unit 160 controls the traveling driving force output device 200, the brake device 210, and the steering device 220 so that the subject vehicle M passes through the target trajectory generated by the action plan generation unit 140 at a scheduled time.

For example, the third control unit 160 includes an acquisition unit 162, a speed control unit 164, and a steering control unit 166. The acquisition unit 162 acquires information on the target trajectory (a trajectory point) generated by the action plan generation unit 140 and stores the information in a memory (not shown). The speed control unit 164 controls the traveling driving force output device 200 or the brake device 210 on the basis of a speed element accompanying the target trajectory stored in the memory. The steering control unit 166 controls the steering device 220 according to a degree of curvature of the target trajectory stored in the memory. For example, a process of the speed control unit 164 and the steering control unit 166 is realized by a combination of a feed-forward control and a feedback control. As an example, the steering control unit 166 is executed by a combination of a feed-forward control according to a curvature of the road ahead of the subject vehicle M and a feedback control based on the deviation from the target trajectory.

The storage unit 180 is constituted with, for example, an HDD, a flash memory, an electrically erasable programmable read only memory (EEPROM), a read only memory (ROM), a random access memory (RAM) or the like. For example, the storage unit 180 stores learning data 182, a determination decision rule table 184, and other various pieces of information. For example, in the learning data 182, a determination result (a second determination result which will be described later) learned by the AI function or the like is associated with information obtained from a part of functions for the subject vehicle M to perform traveling control. For example, a part of functions is a sensing function of each of a plurality of external sensing devices (for example, the camera 10, the radar device 12, and the finder 14) mounted on the subject vehicle M, and a function of the driving support device that executes an LKAS or the like. For example, in the determination decision rule table 184, determination decision rule data is associated with a determination result (a first determination result which will be described later and the second determination result) and external information. For example, the learning data 182 may be acquired from an external device through the communication device 20, or the determination result generation unit 152 may generate and update the learning data 182 at a predetermined timing. Details of the determination decision rule table 184 will be described later.

The traveling driving force output device 200 outputs, to driving wheels, traveling driving force (torque) for enabling the vehicle to travel. For example, the traveling driving force output device 200 includes a combination of an internal combustion engine, an electric motor, a transmission, and the like, and an (electronic control unit) ECU that controls the internal combustion engine, the electric motor, the transmission, and the like. The ECU controls the above-described constitutions according to the information input from the third control unit 160 or the information input from the driving operation element 80.

For example, the brake device 210 includes a brake caliper, a cylinder that transfers oil pressure to the brake caliper, an electric motor that generates the oil pressure in the cylinder, and a brake ECU. The brake ECU controls the electric motor according to the information input from the third control unit 160 or the information input from the driving operation element 80, so that a brake torque according to a control operation is output to each wheel. The brake device 210 may include a mechanism for transferring the oil pressure generated by an operation of a brake pedal included in the driving operation element 80 to the cylinder through a master cylinder as a backup. The brake device 210 is not limited to the constitution described above, and may be an electronic control method oil pressure brake device that controls an actuator according to the information input from the third control unit 160 to transfer the oil pressure of the master cylinder to the cylinder.

For example, the steering device 220 includes a steering ECU and an electric motor. For example, the electric motor changes a direction of steerable wheels by applying a force to a rack and pinion mechanism. The steering ECU changes the direction of the steerable wheels by driving the electric motor according to the information input from the third control unit 160 or the information input from the driving operation element 80.

[Function of Determination Result Generation Unit]

For example, the determination result generation unit 152 generates the first determination result made by the operation of the occupant or the device in relation to a first matter that is related to the traveling of the subject vehicle M and generates the second determination result by performing determination based on the learning data in relation to a second matter that is related to the first determination result 182.

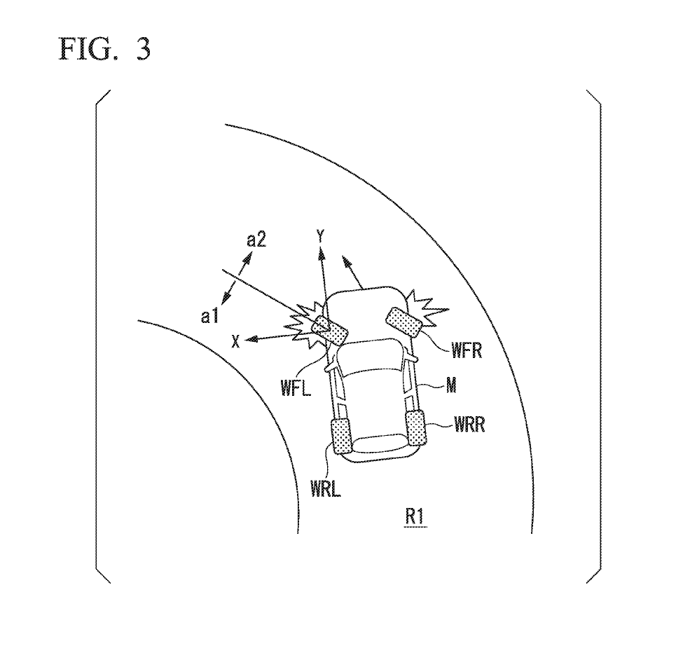

FIG. 3 is a diagram for explaining a process of the determination result generation unit 152. The example of FIG. 3 shows a state in which the subject vehicle M travels on a left curved road R1 slips as the first matter. FIG. 3 schematically shows left and right front wheels WFL and WFR of the subject vehicle M and left and right rear wheels WRL and WRR of the subject vehicle M, and it is assumed that steering angles of the wheels WFL and WFR with respect to a steering amount of the steering wheel are the same. Hereinafter, it is assumed that the wheel WFL is used in the description of steering angle control of the wheel.

For example, in a case where a slip of the subject vehicle M occurs, the determination result generation unit 152 generates the first determination result related to the traveling control of the subject vehicle on the basis of an operation amount of the occupant (an example of the user) received from the steering wheel that is an example of the driving operation element 80.

In the example of FIG. 3, under a situation in which the wheels WFL and WFR of the subject vehicle M are slipping on the left curved road R1 (an example of the first matter), in a case where an operation for turning the steering wheel further left by the occupant is received, the determination result generation unit 152 generates steering control to direct the steering angle of the wheel of the subject vehicle M to a left side (a side of an arrow a1 in the figure) as compared with a current state as the first determination result, on the basis of the steering amount of the steering wheel.

In association with performing the operation for turning the subject vehicle M left by the occupant (an example of the second matter), the determination result generation unit 152 generates steering control to direct the steering angle of the wheel WFL to a right side (a side of an arrow a2 in the figure) as compared with a current state using the learning data 182 by the driving support device that executes the LKAS as the second determination result.

The determination result generation unit 152 may acquire the second determination result corresponding to the second matter by referring to the learning data 182 stored in the storage unit 180 in advance on the basis of the second matter that is related to the first determination result.

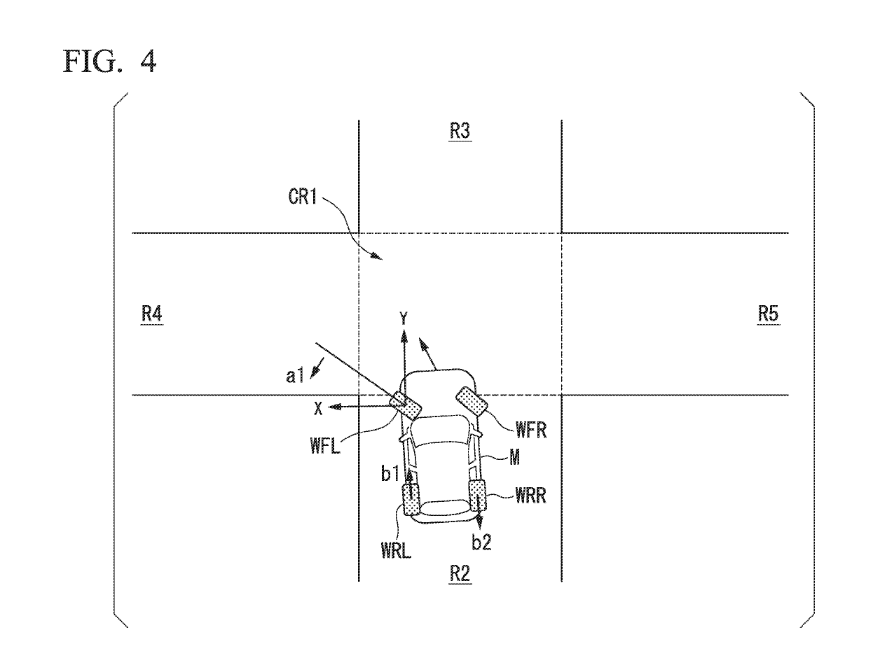

In the process described above, instead of the determination result by the operation of the occupant, the first determination result may be set as a determination result for a control content for the device mounted on the subject vehicle M. FIG. 4 is a diagram for explaining a process of the determination result generation unit 152 in a situation in which the subject vehicle M travels through an intersection. In the example of FIG. 4, a situation is shown in which the subject vehicle M traveling on the road R2 turns left at an intersection CR1 connected to each of roads R2 to R5. In this case, the determination result generation unit 152 generates a control content as the first determination result so as to turn left on the basis of the AI function mounted on the steering control device. On the basis of the AI function installed in the distribution control device of the left and right braking and driving force, the determination result generation unit 152 generates a control content for generating force in a backward direction (b2 direction in the figure) with respect to the vehicle by driving the subject vehicle in a forward direction (b1 direction in the figure) with respect to the rear left wheel WRL and braking the subject vehicle with respect to the rear right wheel WRL as the second determination result, in consideration of grip traveling or turning characteristics (ease of changing the orientation of the subject vehicle M) such that the subject vehicle M exhibits the behavior of not skidding sideways when turning left.

[Function of Determination Decision Unit]

The determination decision unit 154 determines whether or not the first determination result and the second determination result generated by the determination result generation unit 152 are different from each other. For example, the fact that the first determination result and the second determination result are different from each other means that contradiction occurs in the vehicle control due to reflection of a control amount of first traveling control due to the first determination result and a control amount of second traveling control due to the second determination result on the subject vehicle M. For example, the fact that the contradiction occurs in the vehicle control means that directionality of the behavior of the subject vehicle M by execution of the traveling control by the first determination result and directionality of the behavior of the subject vehicle M by execution of the traveling control by the second determination result are contrary to each other. For example, the fact that the directionalities are contrary to each other means that the second determination result instructs turning right while the first determination result instructs turning left. For example, the fact that the directionalities are contrary to each other may mean that that the second determination result instructs the deceleration while the first determination result instructs the acceleration. The fact that the contradiction occurs in the vehicle control may include a case in which a range of one or both of traveling controls is exceeded in a case where traveling control based on one of the first determination result and the second determination result and traveling control based on the other determination result are performed.

In a case where the first determination result and the second determination result are different from each other, the determination decision unit 154 determines a final determination result on the basis of the first determination result, the second determination result, and external information. For example, the external information is a traveling state or a surrounding situation of the subject vehicle M recognized by the recognition unit 130. Specifically, the external information includes information on the behavior of the subject vehicle M, a road shape, a road surface situation, the weather, a surrounding object (obstacle) such as another vehicle, or the like. In the example of FIG. 3, the external information includes information that the subject vehicle M is traveling on the left curved road R1 and that slipping is occurring. In the example of FIG. 4, for example, the external information includes information that the subject vehicle M travels on the road R2 and turns left to the road R4 at the intersection CR1.

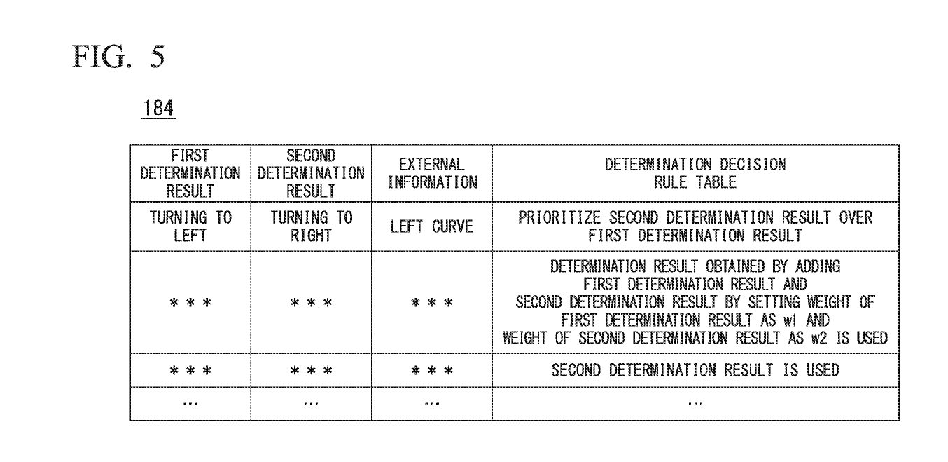

For example, the determination decision unit 154 collates the first determination result, the second determination result, and the external information with the determination decision rule table 184 stored in the storage unit 180, and acquires corresponding determination decision rule data. FIG. 5 is a diagram showing an example of a content of the determination decision rule table 184.

In the determination decision rule table 184, determination decision rule data is associated with determination patterns of the first determination result and the second determination result, and the external information. For example, the determination decision rule data is a determination result related to final traveling control for causing the action plan generation unit 140 to generate the target trajectory. The determination decision rule data may include an adjustment content related to a priority or weights of the first determination result and the second determination result. In the example of FIG. 5, as the determination decision rule data, for example, decision contents, in which the second determination result is prioritized over the first determination result, a determination result obtained by adding the first determination result to the second determination result by setting the weight of the first determination result as w1 and the weight of the second determination result as w2 is used, only one determination result is used, or the like, is included.

The determination decision rule table 184 is acquired from an external device such as a server through the communication device 20. The determination decision rule table 184 may be derived by statistically processing a pattern of a past determination decision result by the determination decision unit 154. The determination decision unit 154 is able to obtain a more suitable determination result on the basis of the surrounding situation by using the external information. It is possible to perform accurate determination at an early stage by referring to the determination decision rule table 184.

In a case where the first determination result and the second determination result are not different from each other, the determination decision unit 154 executes traveling control of both of the first determination result and the second determination result. For example, in a case where both of the first determination result and the second determination result are instructions for turning right, and even though traveling control based on both instructions is performed the range of other traveling control is not exceeded, the determination decision unit 154 determines both of the first determination result and the second determination result as the determination result and performs traveling control based on the determination decision result.

The determination decision unit 154 may feed back the determination decision result (determination decision rule data) to the learning data 182 to update the data. In this case, the determination decision unit 154 may update each time the determination decision result is obtained, or update at a timing at which a certain degree of determination decision result is obtained or at a timing at which a predetermined time has elapsed. As described above, by feeding back the determination decision result in which the traveling control is finally performed to the learning data 182, in a case where identical or similar matters are determined from the next time onward, it is possible to suppress occurrence of difference between the first determination result and the second determination result. Therefore, it is possible to perform more accurate and prompt determination.

[Process Flow]

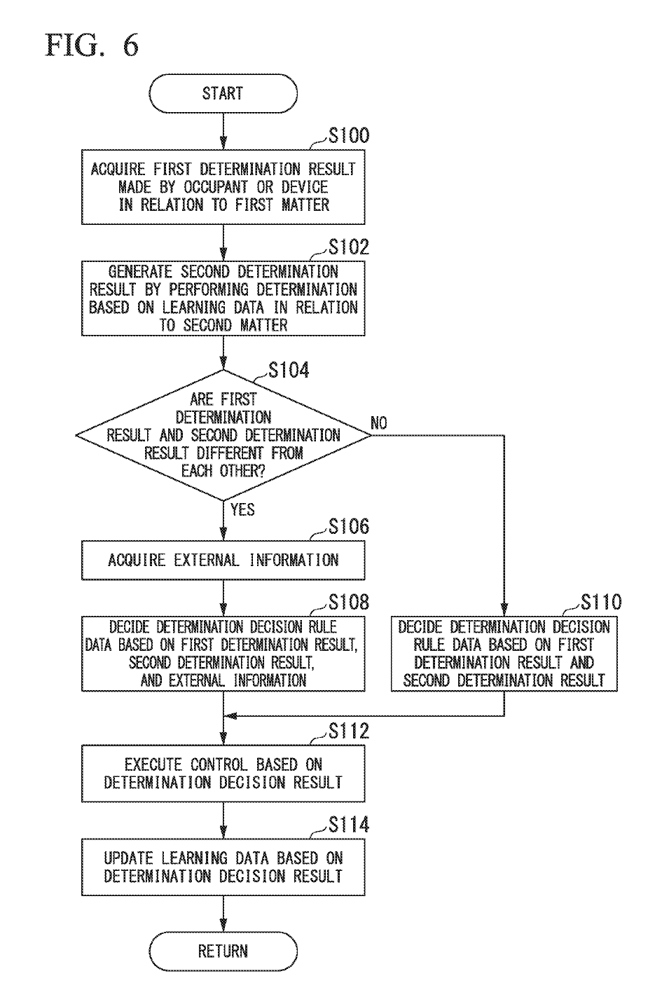

FIG. 6 is a flowchart showing a flow of a process executed by the driving support control device 100 of the first embodiment. For example, the process of the present flowchart may be repeatedly executed at a predetermined period or at a predetermined timing. At a time at which the present flowchart is started, it is assumed that the target trajectory is generated by the action plan generation unit 140 and the automated driving is executed by the third control unit 160 on the basis of the generated target trajectory.

For example, the determination result generation unit 152 acquires the first determination result made by the occupant or the device in relation to the first matter (step S100). Next, the determination result generation unit 152 generates the second determination result by performing the determination based on learning data 182 in relation to the second matter that is related to the first determination result (step S102).

Next, the determination decision unit 154 determines whether or not the first determination result and the second determination result are different from each other (step S104). In a case where the first determination result and the second determination result are different from each other, the determination decision unit 154 acquires the external information (step S106), and decides the determination decision rule data with reference to the determination decision rule table 184, on the basis of the first determination result, the second determination result, and the external information (step S108).

In the process of step S104, in a case where the first determination result and the second determination result are not different from each other, the determination decision unit 154 decides the determination decision rule data on the basis of the first determination result and the second determination result (step S110). Next, the determination decision unit 154 outputs the determination decision result obtained by the process of step S108 or S110 to the action plan generation unit 140, and causes the traveling control to be executed based on the determination decision result (step S112). Next, the determination decision unit 154 feeds back the determination decision result to the learning data 182 (step S114). Therefore, the process of the present flowchart is ended.

As described above, according to the driving support control device 100 of the first embodiment, it is possible to perform more suitable control determination with respect to the vehicle. Specifically, according to the first embodiment, since it is sufficient for the determination result generation unit 152 to generate the determination result by concentrating on each determination matter by using the AI function or the like mounted on each of the devices that execute a part of a function of the traveling control mounted on the subject vehicle M, it is possible to reduce a process load and improve an individual learning accuracy at an early stage. According to the first embodiment, in a case where the first determination result and the second determination result are different from each other, the determination decision unit 154 determines the final determination also based on the external information, and thus it is possible to perform accurate determination at an early stage.

### Second Embodiment

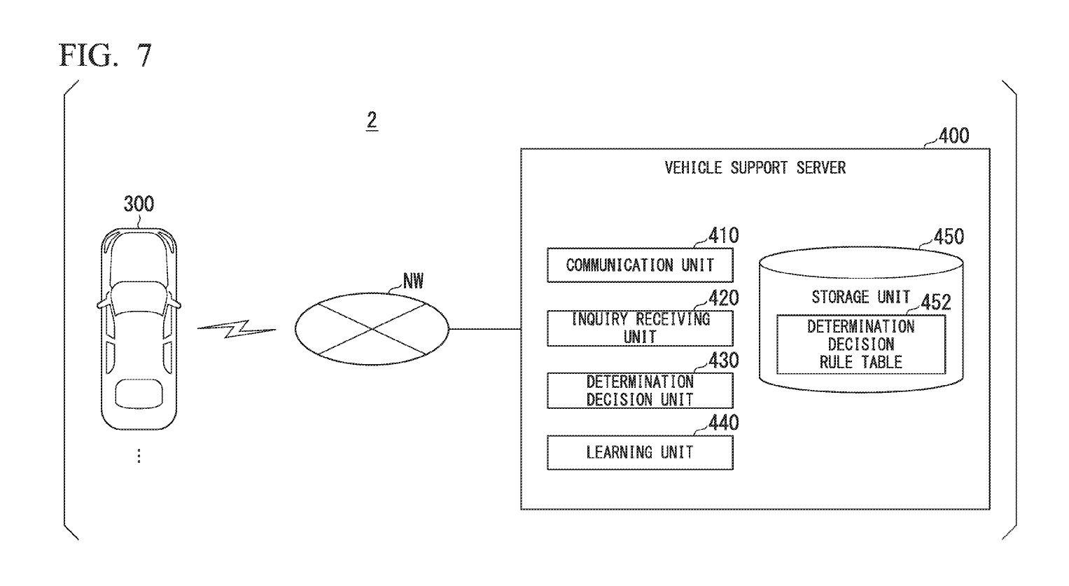

Next, a vehicle system of a second embodiment will be described. In the second embodiment, it is assumed that the determination decision unit 154 is not provided in a vehicle and the traveling control is performing using a determination decision result of a vehicle support server present in the outside. FIG. 7 is a constitution diagram of the vehicle system 2 of the second embodiment. The vehicle system 2 includes, for example, one or more vehicles 300 and a vehicle support server 400. Such constitution elements are able to communicate with each other through the network NW. The network NW includes the Internet, a wide area network (WAN), a local area network (LAN), a public line, a provider device, a dedicated line, a wireless base station, and the like.

[Vehicle]

A vehicle 300 includes, for example, the subject vehicle M and the other vehicle of the first embodiment. For example, the vehicle 300 has a difference in that the vehicle 300 includes a driving support control device 100A instead of the driving support control device 100 as compared with the constitution diagram of the vehicle system 1 of the first embodiment. Therefore, hereinafter, a function of the driving support control device 100A will be mainly described.

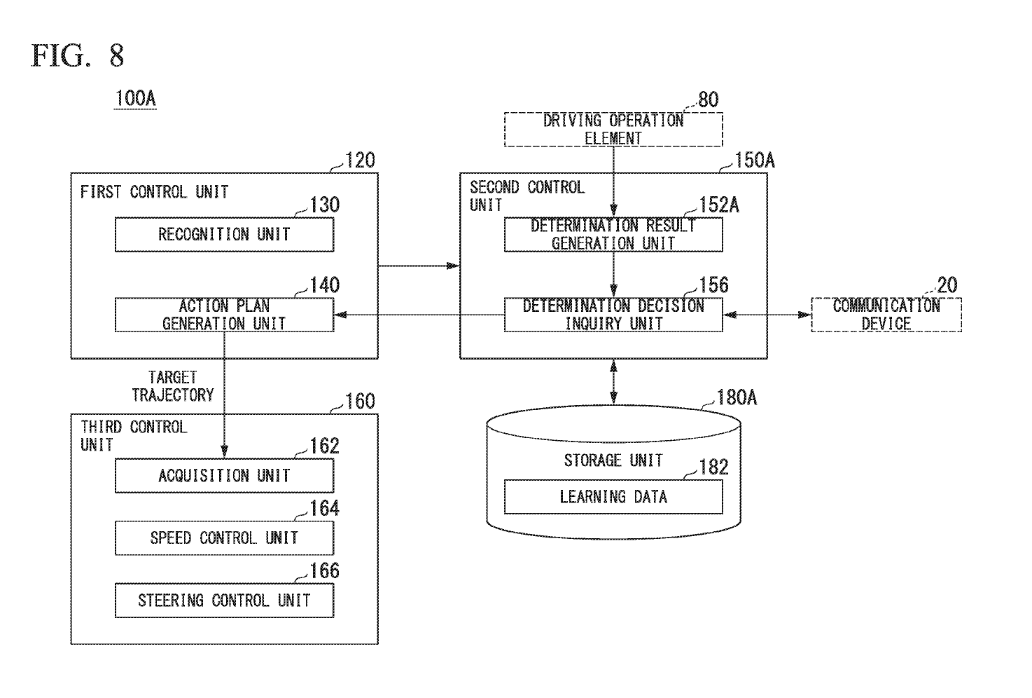

FIG. 8 is a functional constitution diagram of the first control unit 120, a second control unit 150A, the third control unit 160, and the storage unit 180A according to the second embodiment. The driving support control device 100A shown in FIG. 8 has a difference in that the driving support control device 100A includes a determination decision inquiry unit 156 instead of the determination decision unit 154, and a storage unit 180A instead of the storage unit 180 as compared with the driving support control device 100 of the first embodiment. Therefore, hereinafter, the determination decision inquiry unit 156 and the storage unit 180A will be mainly described.

[Function of Determination Decision Inquiry Unit]

The determination decision inquiry unit 156 determines whether or not the first determination result and the second determination result generated by the determination result generation unit 152 are different from each other. In a case where the first determination result and the second determination result are different from each other, for example, the determination decision inquiry unit 156 transmits the first determination result, the second determination result, and inquiry information of the final determination decision rule data together with the external information and the like recognized by the recognition unit 130 to the vehicle support server 400 through the communication device 20.

In addition, the determination decision inquiry unit 156 acquires the determination decision rule data from the vehicle support server 400. The determination decision inquiry unit 156 outputs the determination decision rule data to the action plan generation unit 140. The determination decision inquiry unit 156 may feed back the determination decision rule data to the learning data 182 in the storage unit 180A to update the data.

[Function of Vehicle Support Server]

Returning to FIG. 7, the vehicle support server 400 includes, for example, a communication unit 410, an inquiry receiving unit 420, a determination decision unit 430, a learning unit 440, and a storage unit 450. For example, each of the inquiry receiving unit 420, the determination decision unit 430, and the learning unit 440 is realized by a hardware processor such as a CPU executing a program (software). A part or all of such constitution elements may be realized by hardware (including a circuit unit; circuitry) such as an LSI, an ASIC, an FPGA, a GPU, or the like, or may be realized by cooperation of software and hardware. The program may be stored in a storage device such as an HDD or a flash memory of the driving support control device 100A in advance. Alternatively, the program may be stored in a detachable storage medium such as a DVD or a CD-ROM and may be installed in the HDD or the flash memory of the driving support control device 100A by attachment of the storage medium to a drive device. The storage unit 450 is constituted with, for example, an HDD, a flash memory, an electrically erasable programmable read only memory (EEPROM), a read only memory (ROM), a random access memory (RAM), or the like. For example, the storage unit 450 stores a determination decision rule table 452 and other various pieces of information. For example, matter similar to the determination decision rule table 184 is stored in the determination decision rule table 452.

The communication unit 410 is, for example, a network card connected to the network NW. The communication unit 410 communicates with the vehicle 300 and another external device through network NW.

The inquiry receiving unit 420 receives the first determination result, the second determination result, and an inquiry of the determination result data from the vehicle 300.

The determination decision unit 430 acquires determination decision rule data corresponding to the first determination result, the second determination result, and the external information by referring to the determination decision rule table 452 stored in the storage unit 450, on the basis of the information received by the inquiry receiving unit 420.

The learning unit 440 stores information related to the first determination result, the second determination result, and the external information, and the determination decision rule data decided by the determination decision unit 430 in the storage unit 450, performs learning such as a statistical process after a predetermined time has elapsed or at a timing at which a predetermined amount of data is accumulated, and updates the determination decision rule table 452 on the basis of a result of the learning. Therefore, since the learning unit 440 updates the determination decision rule table 452 using the data obtained from the plurality of vehicles 300, it is possible to perform determination of suitable traveling control according to various situations.

According to the second embodiment, since it is possible to acquire the determination decision rule data from a side of the vehicle support server 400, it is possible to reduce a process load on a side of the vehicle 300. According to the second embodiment, since the vehicle support server 400 is able to perform learning using the information from the plurality of vehicles 300, it is possible to acquire more suitable determination decision rule data according to various situations.

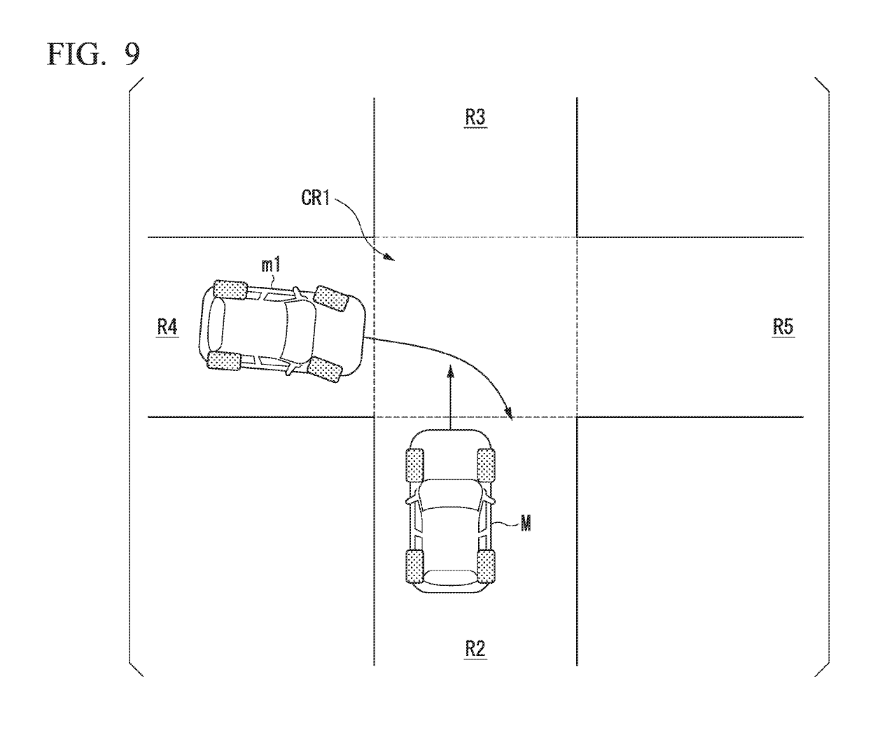

For example, the second embodiment is also able to be applied to driving control for avoiding contact between vehicles. FIG. 9 is a diagram for explaining a process of the driving support control device 100A at an intersection. In FIG. 9, the subject vehicle M (an example of a first vehicle) that is an example of the vehicle 300, and the other vehicle ml (an example of a second vehicle) are shown. The intersection CR1 is an intersection where a traffic light is not installed. It is assumed that the subject vehicle M goes straight ahead from the road R2 to the road R3 and the other vehicle ml turns right from the road R4 to the road R2.

In such a situation, the subject vehicle M stops because the other vehicle ml is present in a progress direction ahead of the intersection CR1. The other vehicle ml also stops because the subject vehicle M is present in a progress direction ahead of the intersection CR1. In this case, since each other are in a stopped state, smooth traveling may not be possible in some cases. Therefore, the determination decision inquiry units 156 of each of the subject vehicle M and the other vehicle ml transmit respective determination results and respective pieces of external information (for example, a traveling state, a surrounding situation) to the vehicle support server 400, and inquire the determination decision rule data. In this case, for example, a determination result of an obstacle (the position of the other vehicle) and a determination result of a possibility of contact with the obstacle may be included as the external information. The external information may include information obtained from a camera, a radar device, a finder, or the like installed in the vicinity of the intersection CR1.

The inquiry receiving unit 420 of the vehicle support server 400 receives inquiry information of the subject vehicle M and the other vehicle ml. The determination decision unit 430 acquires the determination result related to the traveling control of the automated driving control of the subject vehicle as the first determination result and the determination result related to the traveling control of the automated driving control of the other vehicle ml as the second determination result. The determination decision unit 430 refers to the determination decision rule table 452 on the basis of the external information in the subject vehicle M and the other vehicle ml, and acquires corresponding determination decision rule data. In this case, for example, the determination decision rule data is data for decelerating or stopping one or both of the subject vehicle M and the other vehicle ml. In the determination decision rule data, rule data related to a vehicle to which deceleration release or departure is prioritized by the determination decision unit 430 after decelerating or stopping one or both of the subject vehicle M or the other vehicle ml is included. The determination decision unit 430 transmits the determination decision rule data to the subject vehicle M and the other vehicle ml. Therefore, the subject vehicle M and the other vehicle ml are able to smoothly travel at the intersection CR1.

[Process Sequence]

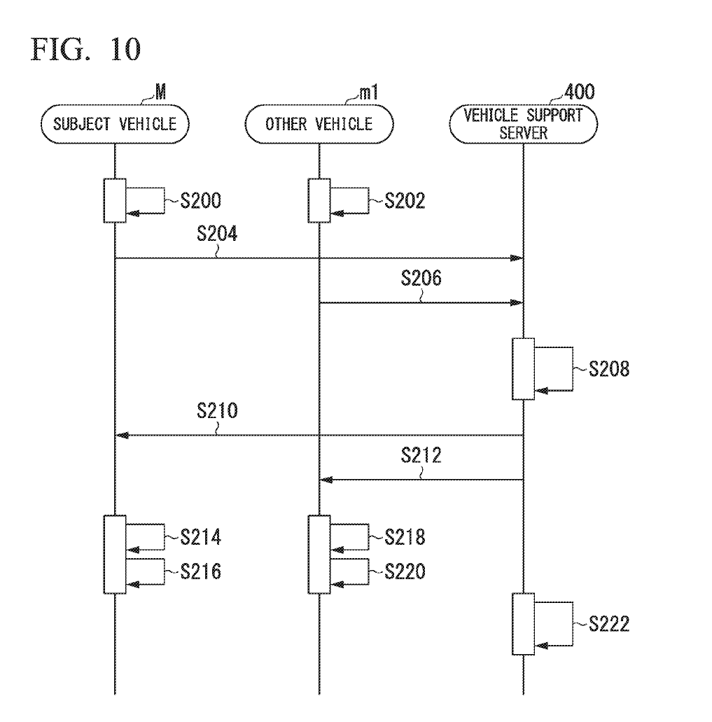

FIG. 10 is a sequence diagram showing a flow of a process executed by the driving support control device 100A of the second embodiment. For example, the process of the present sequence may be repeatedly executed at a predetermined period or a predetermined timing. For convenience of description, the sequence diagram shown in FIG. 10 shows the subject vehicle M, the other vehicle ml, and the vehicle support server 400, and shows a flow of a process in the situation shown in FIG. 9. At a time at which the present sequence is started, it is assumed that the target trajectory is generated by each action plan generation unit 140 of the subject vehicle M and the other vehicle ml, and the automated driving is executed by the third control unit 160 on the basis of the generated target trajectory.

In the example of FIG. 10, the subject vehicle M generates a determination result for going straight ahead at the intersection CR1 (step S200). The other vehicle ml generates a determination result for turning right at the intersection CR1 (step S202). Next, the subject vehicle M and the other vehicle ml transmit the inquiry information of the determination decision rule data together with the respective determination results and the external information to the vehicle support server 400 (steps S204 and S206).

Next, the vehicle support server 400 refers to the determination decision rule table 452 on the basis of the respective determination results of the subject vehicle M and the other vehicle ml and the external information, and acquires the corresponding determination decision rule data (step S208). Next, the vehicle support server 400 transmits determination decision rule data to the subject vehicle M and the other vehicle ml with respect to the subject vehicle M and the other vehicle ml (steps S210 and S212).

Next, the subject vehicle M generates the target trajectory on the basis of the determination decision rule data received from the vehicle support server 400, and travels along the generated target trajectory (step S214). The subject vehicle M may update the learning data on the basis of the determination decision rule data received from the vehicle support server 400 (step S216). The other vehicle ml generates a target trajectory on the basis of the determination decision rule data received from the vehicle support server 400, and travels along the generated target trajectory (step S218). The subject vehicle M may update the learning data on the basis of the determination decision rule data received from the vehicle support server 400 (step S220).

Next, the vehicle support server 400 stores the determination decision rule data obtained by the process of step S208 in the storage unit 450, and performs a statistical process or the like at a predetermined timing to update the determination decision rule table 452 (step S222). Therefore, the process of the present sequence is ended.

According to the second embodiment described above, by not having the determination decision unit in each vehicle, it is possible to suppress a risk in a case where the determination decision units of the respective determination decision units have different determination results. Although a plurality of external sensing devices are mounted on the vehicle, even in a case where the results by the learning data of such sensing functions are different from each other, it is possible to promptly perform accurate determination by acquiring the traveling state and the surrounding situation. According to the second embodiment, for example, in consideration of a mutual contact possibility at an intersection or the like where a traffic light is not installed, it is possible to solve a state in which each is not able to automatically start in a state in which each is stopped, it is possible to realize smooth traffic.

In the first and second embodiments, a part or all of the other embodiments may be combined. Each of the determination result generation unit and the determination decision unit in the first and second embodiments also may use machine learning and depth learning such as deep learning and support vector machine.

[Hardware Constitution]

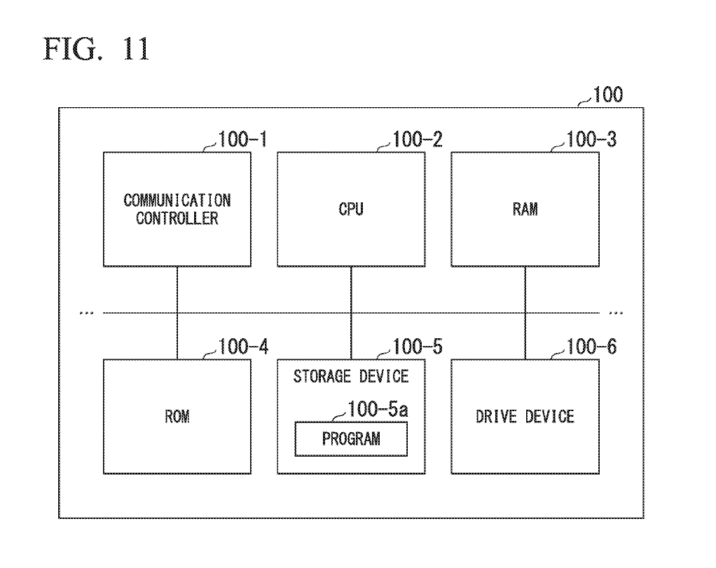

FIG. 11 is a diagram showing an example of a hardware constitution of the driving support control device 100 or 100A according to an embodiment. As shown in the figure, the driving support control device 100 or 100A includes a constitution in which a communication controller 100-1, a CPU 100-2, a RAM 100-3 used as a working memory, a ROM 100-4 storing a boot program and the like, a storage device 100-5 such as a flash memory or an HDD, a drive device 100-6 and the like are mutually connected by an internal bus or a dedicated communication line. The communication controller 100-1 communicates with components other than the driving support control device 100 or 100A. A portable storage medium (for example, a computer readable non-transitory storage medium) such as an optical disk is attached to the drive device 100-6. A program 100-5a executed by the CPU 100-2 is stored in the storage device 100-5. This program is developed in the RAM 100-3 by a direct memory access (DMA) controller (not shown) or the like and executed by the CPU 100-2. The program 100-5a referred to by the CPU 100-2 may be stored in the portable storage medium attached to the drive device 100-6 or may be downloaded from another device through the network.

Therefore, a part or all of the first control unit 120, the second control unit 150, and the third control unit 160 of the driving support control device 100 are realized, and a part or all of the first control unit 120, the second control unit 150A, and the third control unit 160 of the driving support control device 100A are realized. The hardware constitution shown in FIG. 11 is also able to be applied to the hardware constitution of the vehicle support server 400. Therefore, for example, a part or all of the inquiry receiving unit 420, the determination decision unit 430, and the learning unit 440 of the vehicle support server 400 are realized.

The above-described embodiment is able to be expressed as follows.

A vehicle control device including:

a storage device that stores a program; and

a hardware processor,

wherein the hardware processor executes the program stored in the storage device to:

generate a first determination result made by an occupant or a device in relation to a first matter that is related to traveling of a subject vehicle and a second determination result by performing determination based on learning data in relation to a second matter that is related to the first determination result; and

decide determination related to the first matter and the second matter based on the first determination result, the second determination result, and external information, in a case where the first determination result and the second determination result are different from each other.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control system comprising:
a determination result generation unit that generates a first determination result made by an occupant or a device mounted on a subject vehicle in relation to a first matter that is related to traveling of the subject vehicle and generates a second determination result by performing determination based on learning data in relation to a second matter that is related to the first determination result; and
a determination decision unit that decides a determination related to the first matter and the second matter based on the first determination result, the second determination result, and external information, in a case where the first determination result and the second determination result are different from each other.

2. The vehicle control system of claim 1,
wherein the determination decision unit decides the determination related to the first matter and the second matter with reference to a table capable of acquiring determination decision rule data for deciding the determination related to the first matter and the second matter, based on a combination of a determination pattern of the first determination result and the second determination result and the external information.

3. The vehicle control system of claim 1,
wherein the determination decision unit feeds back the determination result decided based on the first determination result, the second determination result, and the external information to the learning data.

4. The vehicle control system of claim 1,
wherein the determination result generation unit sets a determination result related to a control amount of first traveling control of the subject vehicle as the first determination result and sets a determination result related to a control amount of second traveling control of the subject vehicle as the second determination result,
the external information includes a traveling state or a surrounding situation of the subject vehicle, and
the determination decision unit adjusts one or both of the control amount of the first traveling control and the control amount of the second traveling control based on the external information in a case where contradiction occurs in vehicle control by reflecting the control amount of the first traveling control and the control amount of the second traveling control on the subject vehicle.

5. The vehicle control system of claim 1,
wherein the determination result generation unit sets a determination result related to traveling control of automated driving control of a first vehicle as the first determination result and sets a determination result related to traveling control of automated driving control of a second vehicle as the second determination result,
the external information includes traveling states or surrounding situations of the first vehicle and the second vehicle, and
in a case where there is a possibility that the first vehicle and the second vehicle come in contact with each other, the determination decision unit decelerates or stops one or both of the first vehicle or the second vehicle based on the first determination result, the second determination result, and the external information.

6. The vehicle control system of claim 5,
wherein the determination decision unit decides a vehicle in which deceleration is to be stopped or which is to be preferentially started after decelerating or stopping the first vehicle and the second vehicle.

7. The vehicle control system of claim 5,
wherein the determination decision unit decelerates or stops one or both of the first vehicle or the second vehicle based on a first determination result based on a determination result of an obstacle based on the traveling state or a surrounding situation of the first vehicle and a determination result of a possibility of contact with the obstacle, a second determination result based on a determination result of an obstacle based on the traveling state or the surrounding situation of the second vehicle and a determination result of a possibility of contact with the obstacle, and the external information.

8. The vehicle control system of claim 5,
wherein the determination decision unit is provided in an external device capable of communicating with the first vehicle and the second vehicle.

9. A vehicle control system comprising:
an operation receiving unit that receives an operation of a user;
a determination result generation unit that generates a determination result based on learning data in relation to a first matter; and
a determination decision unit that decides a determination related to the first matter based on the determination result of the determination result generation unit, the operation received by the operation receiving unit, and external information, in a case where an operation different from the determination result determined by the determination result generation unit is performed based on the operation received by the operation receiving unit.

10. A vehicle control method that causes a vehicle control system to:
generate a first determination result made by an occupant or a device in relation to a first matter that is related to traveling of a subject vehicle and generate a second determination result by performing determination based on learning data in relation to a second matter that is related to the first determination result; and
decide determination related to the first matter and the second matter based on the first determination result, the second determination result, and external information, in a case where the first determination result and the second determination result are different from each other.

11. A computer-readable non-transitory storage medium storing a program that causes a vehicle control system to:
generate a first determination result made by an occupant or a device in relation to a first matter that is related to traveling of a subject vehicle and generate a second determination result by performing determination based on learning data in relation to a second matter that is related to the first determination result; and
decide determination related to the first matter and the second matter based on the first determination result, the second determination result, and external information, in a case where the first determination result and the second determination result are different from each other.
